(19) United States
(12) Patent Application Publication
(10) Pub. No.: US 2003/0072456 A1
(43) Pub. Date: Apr. 17, 2003

(54) Acoustic source localization by phase signature

(76) Inventor: David Graumann, Portland, OR (US)

Correspondence Address: Pillsbury Winthrop LLP, Intellectual Property Group, Suite 2800, 725 South Figueroa Street, Los Angeles, CA, 90017-5406, US

(21) Appl. No.: 09/981,389

(22) Filed: Oct. 17, 2001

(51) Int. Cl. H04B 3/20

(52) U.S. Cl. 381/66

(57) ABSTRACT

A sound location detecting system includes a first microphone located at a first location to detect acoustic waves at the first location. A second microphone is located at a second location to detect the acoustic waves at the second location. At least one acoustically reflective surface reflects the acoustic waves. An acoustic analysis device detects and analyzes the acoustic waves. A processing device determines a spatial location of a source of the acoustic waves.

### BACKGROUND OF THE INVENTION

1. Field of the Invention

The present invention generally relates to the art of analyzing sound waves to determine the spatial location of a source of the sound waves. More specifically, the present invention relates to a system, method, and apparatus to determine the spatial location of a sound source by utilizing pairs of microphones in combination with acoustically reflective surfaces.

2. Discussion of the Related Art

There are source localization systems in the art that utilize a plurality of microphones to enhance an electrical signal created when a sound is detected. Such systems are often designed to maximize some aspect of the outputted electrical signal based upon the location of a sound source. Several methods are currently utilized to determine the location of the sound source.

One method is the Delay and Sum Beamformer method. FIG. 1 illustrates a Delay and Sum Beamformer embodiment that has been used in the prior art. The embodiment sums the signal outputs of three microphones 105, 110, and 115 to generate a resultant signal. The embodiment includes delay circuits 120, 125, and 130 for each of the microphones to delay the output of each microphone for a predetermined amount of time. The delays are determined based upon the difference in the amount of time it takes for sound to reach each of the microphones. The delays are set so that sound produced by a sound source 100 located at a predetermined location can be converted into an electrical signal with high power by the microphones and delays. For example, if the third microphone 115 is furthest from the sound source 100, delay A 120 will delay the output of the first microphone 105 for the difference in the amount of time it takes the sound to travel to the third microphone, versus the amount of time it takes to reach the first microphone 105. Delay B 125 is configured in a similar same way. In such an instance delay C 130 can have a delay of zero.

The output from each of the delay circuits is then summed by a summer 135. For a sound source at the location set for the delays, the output signal of the summer 135 is stronger (i.e., contains more energy) than that which could have been output by any single microphone. Consequently, the total energy of sounds produced at other locations is decreased. The signal is therefore built up constructively and has an increased Signal-to-Noise Ratio (SNR) at the location of interest (i.e., the location for which the delays are set), and a lower level of SNR at the location of disinterest (i.e., a location for which the delays are not set). Each additional microphone typically provides a 3 dB increase in sensitivity with respect to other noise signals that are not part of the sound from the sound source 100.

However, the Delay and Sum Beamforming method is ineffective in accurately determining the location of a sound source 100. Therefore, a Filter and Sum Beamforming Method has been utilized. The Filter and Sum Beamforming Method is similar to the Sum and Delay Beamforming method, except that filters are used in the place of the simple delays. The filters are convolutional delays that can incorporate many types of simple delays. The filters are often preset. Thus, if the sound source moves from the location for which the filter was configured, the filter becomes inappropriate because the sounds detected by the microphones cannot be constructively combined.

Both the Delay and Sum and the Filter and Sum Beamforming Methods can be steered to different locations by applying filter coefficients for the locations of interest. Then, analysis of the signal can be done and analysis of signal power is compared at the different locations. Characteristics of the delays or filters are used to determine the location of the sound source 100.

High Resolution Spectral Analysis is another method that has been utilized to determine the location of a sound source. In this method, all analysis is done in the frequency domain, rather than in the time domain. The relationships of the microphones to each other are analyzed. Spectral resolution is increased above the sampling rate of the microphones by standard padding practice. This method results in better time resolution than is possible at the true sampling rate. The method searches for a tight correlation between different signals coming out of the microphones at different frequencies. The signals are then combined and converted back to the time domain. Accordingly, the method searches for a correlation, rather than the strongest power. The correlation is then utilized to determine the source location. This method has drawbacks, however, in that the spectral analysis is slow and many microphones must be utilized.

Time Difference of Arrival is an additional method that has been utilized to determine the location of a sound source. The method locates a signal with one microphone and determines how long it takes for the signal to reach a second microphone in a pair of microphones. Many other pairs of microphones are also utilized. The angles of incidence between a plane formed by the two microphones may therefore be measured. A drawback of this method, however, is that many pairs of microphones must be utilized to precisely determine the location of the sound source.

### BRIEF DESCRIPTION OF THE DRAWINGS

FIG. 1 illustrates a Delay and Sum Beamformer that has been used in the prior art;

FIG. 2 illustrates an acoustic localization system having a pair of microphones located near acoustically reflective surfaces according to an embodiment of the present invention;

FIG. 3A illustrates a sine wave according to an embodiment of the present invention;

FIG. 3B illustrates a phase difference between when a sine wave reaches microphone M1 and when it reaches microphone M2 according to an embodiment of the present invention;

FIG. 4 illustrates an acoustic localization system having irregularly shaped right and left reflectors according to an embodiment of the present invention;

FIG. 5 illustrates a calibration process according to an embodiment of the present invention;

FIG. 6 illustrates a phase signature table according to an embodiment of the present invention; and

FIG. 7 illustrates a videoconferencing system according to an embodiment of the present invention.

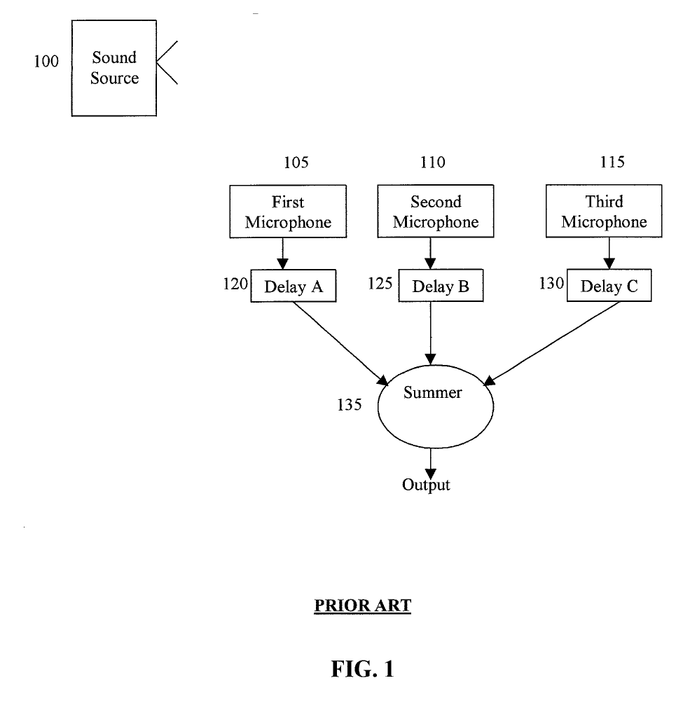

### DETAILED DESCRIPTION

According to an embodiment of the present invention, a pair of microphones, or many pairs of microphones, in combination with an acoustically reflective surface, may be utilized to precisely determine the spatial location of a sound source. The embodiment analyzes the acoustic characteristics of detected sounds and compares them with predetermined sound data to determine the spatial location of the source of the sounds. In general, the more pairs of microphones that are used, the greater the precision of the system.

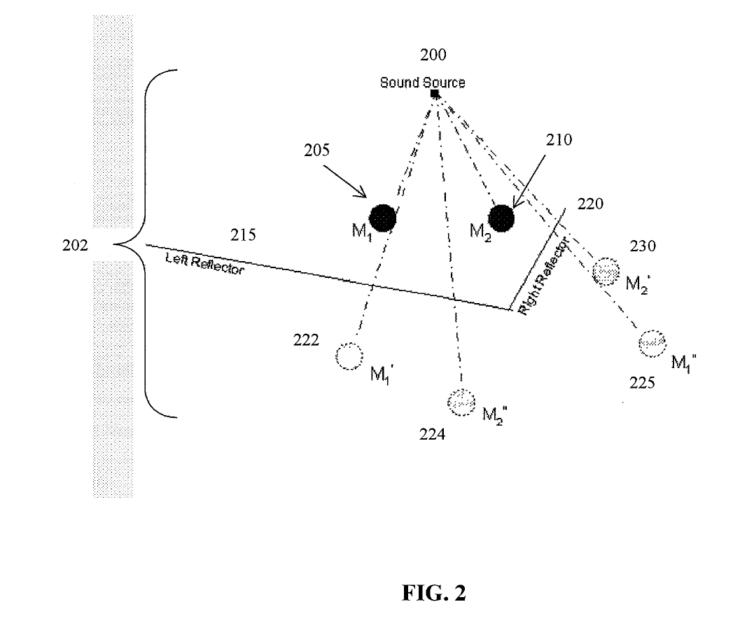

FIG. 2 illustrates an acoustic localization system 202 having a pair of microphones, M1 205 and M2 210, located near acoustically reflective surfaces 215 and 220 according to an embodiment of the present invention. A sound source 200 may be utilized to calibrate the acoustic localization system 202. The left reflector 215 and a right reflector 220 reflect sound waves into the microphones M1 205 and M2 210. The acoustic localization system 202, once calibrated, may precisely determine the spatial location of the sound source 200 within a predetermined area. When a sound source 200 is present in the acoustic localization system 202, the location of the sound source 200 may be determined based upon an analysis of the sound waves that come into contact, directly or indirectly (i.e., after bouncing off of the left 215 or right 220 reflector), with microphones M1 205 or M2 210.

Each of the left reflector 215 and right reflector 220 may be formed of a solid substance having low acoustic absorption properties. In other words, the substances reflect the vast majority of sound waves contacting them, rather than absorbing them. A firm plastic material having low acoustic absorption properties may be a suitable material to form the left 215 and right 220 reflectors.

Because the right reflector 220 and the left reflector 215 are utilized, the acoustic localization system 202 functions as though many microphones other than M1 205 and M2 210 are present. As illustrated in FIG. 2, M2′ 230 is a reflection of microphone M2 through the right reflector 220. M2′ 230 is therefore known as an “apparent microphone,” because it does not physically exist, although the acoustic localization system 202 functions as though M2′ 230 does exist. In FIG. 2, a sound wave directed toward M2′ 230 may be reflected to M2 210 by the right reflector 220. In other words, for a comparable system to function like the current acoustic location system 202 without the right 220 and left 215 reflector, such a system would need to have a microphone located where M2′ 230 is located. The same is true of the other illustrated apparent microphones M1′ 222, M1″ 225, and M2″ 224. The acoustic localization system 202 may also operate as though additional apparent microphones are present. The number of apparent microphones is dependent on the properties of the sound (e.g., the frequency) from the sound source 200 as well as the shape of the left 215 and right 220 reflectors.

When sound waves are present in the acoustic localization system 202, the sound waves contacting microphones M1 205 and M2 210 are analyzed. The data from the analysis is utilized to determine the spatial location of a sound source 200. Specifically, the data from the analysis is compared against a priori (i.e., predetermined) data to determine the location of the sound source 200.

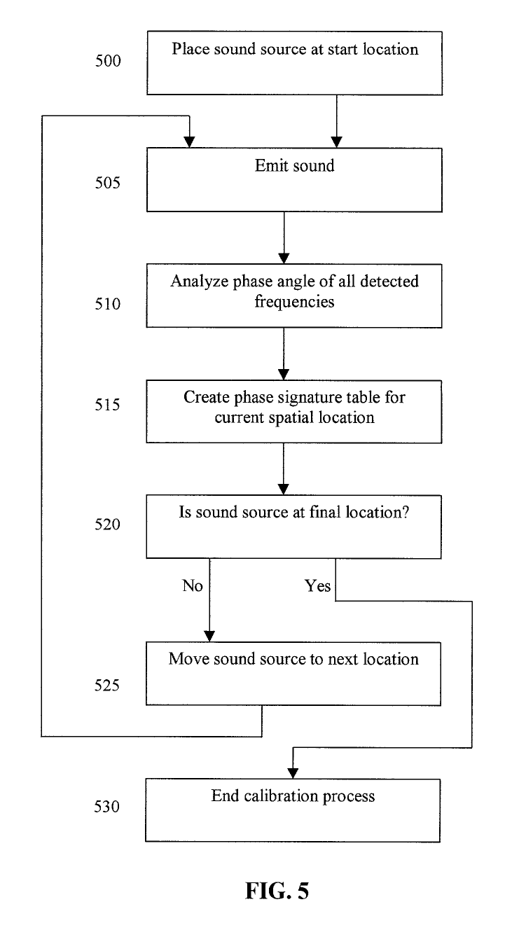

The a priori data is calculated during a calibration process, as discussed in further detailed below with respect to FIG. 5. The a priori data includes phase angles for frequencies from known spatial locations within the acoustic localization system 202. A phase angle is the difference in phase between when a wave at a particular frequency reaches the microphone M1 205 and when it reaches microphone M2 210.

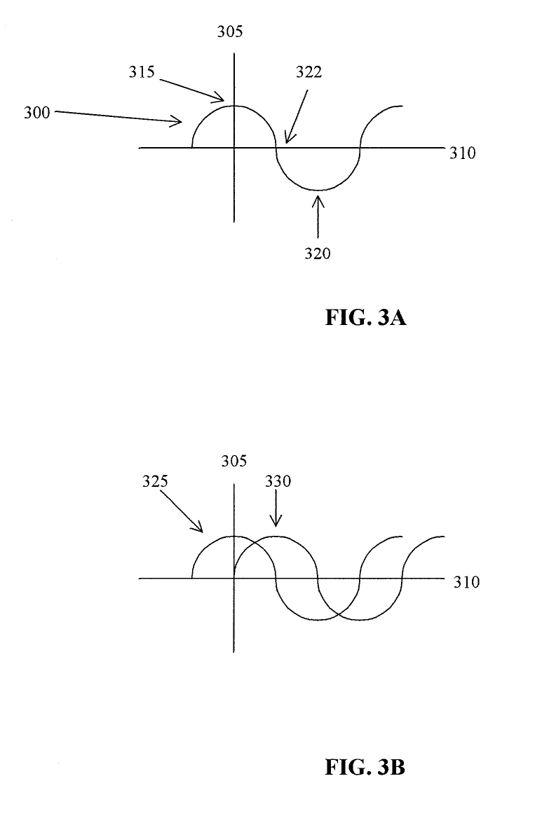

FIG. 3A illustrates a sine wave 300 according to an embodiment of the present invention. The y-axis 305 represents power and the x-axis 310 represents time. The top 315 of the first sine wave 300 is known as the “peak,” and the bottom 320 is known as the “trough.” As illustrated, the peak 305 of the sine wave 300 is on the y-axis 305 at a location where x=0. In a situation where the sine wave 300 contacts both microphone M1 205 and M2 210, there is typically a phase angle calculated between when the sine wave 300 reaches microphone M1 205 and when it reaches the microphone M2 210. In addition, the reflections of the sine wave arrive at both microphones M1 205 and M2 210 at different times. This may cause a very complex phase signature.

FIG. 3B illustrates a phase difference between when the sine wave 300 reaches microphone M1 205 and when it reaches microphone M2 210 according to an embodiment of the present invention. As shown, the first detection 325 of sine wave 300 reaches microphone M1 205 before the second detection 330 of sine wave 300 reaches microphone M2 210. Sine waves 300 are periodic waves that include 360° in each cycle. There are 180° between the peak 315 and the trough 320 of the first sine wave 300, and 90° between the peak 315 and the point 322 at which the first sine wave 300 crosses the x-axis 310. Therefore, the first detection 325 of sine wave 300 by microphone M1 205 leads the second detection 330 of sine wave 300 by microphone M2 210 by 90°.

Although the embodiment illustrated in FIG. 2 includes a left 215 and a right 220 reflector that are straight surfaces, other embodiments may utilize surfaces that are not straight. Many embodiments may utilize right 220 and left 215 reflectors that have irregular shapes. Additional embodiments may also utilize only one reflector, or may utilize more than two reflectors.

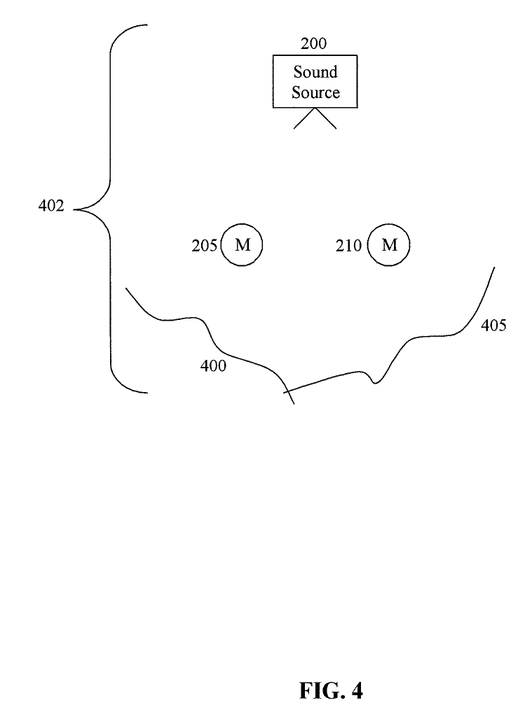

FIG. 4 illustrates an acoustic localization system 402 having irregularly shaped right 405 and left 400 reflectors according to an embodiment of the present invention. As illustrated, neither the left 400 nor the right 405 reflectors are straight. Reflectors with an irregular shape provide additional phase variation, resulting in improved spatial distinction during analysis. Consequently, linear phase relationships between frequencies are removed. A suitable reflector may be shaped like the outer ear of human beings, known as the “pinnea.”

During a calibration process, sound waves comprised of different frequencies are reflected off of the right 405 and left 400 reflectors. Depending on the shape of the right 405 and left 400 reflectors, the phase difference between when the waves contacting microphone M1 205 and microphone M2 210 vary, based upon the frequency of the wave. For example, waves of a relatively high frequency may reflect off the left reflector 400 at a larger angle than waves of a lower frequency.

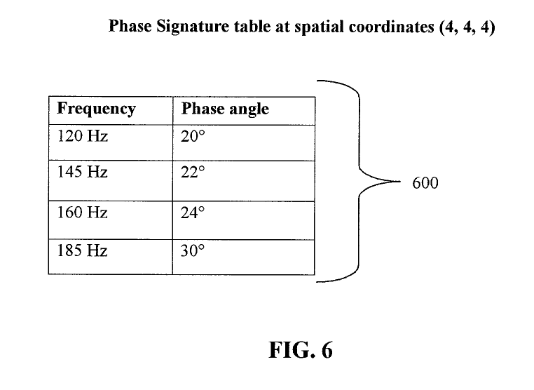

The acoustic localization system 402 moves a sound source 200 to many locations during a calibration process. At each point, the sound source 200 emits sound waves and measures the phase differences between waves detected by microphone M1 205 and waves detected by microphone M2 210. Spoken sounds are typically composed of multiple sound waves of different frequencies. Sound waves of differing frequencies may reflect off of the left 400 or right 405 reflectors at differing angles of incidence (i.e., the “reflection angles”). Therefore, the system determines phase angles for sets of frequencies at all spatial locations of interest. These are then stored in phase signatures, as discussed in further detail below with respect to FIGS. 5 and 6.

FIG. 5 illustrates the calibration process according to an embodiment of the present invention. First, the sound source 500 is placed at a starting location within a predetermined spatial area. Coordinates may be utilized to pinpoint each spatial location. For example, in a situation where the tested area consists of a 10 feet×10 feet×10 feet space, the system may start the calibration process with the sound source as far away as possible at a coordinate (10 feet, 10 feet, 10 feet) 10 feet away in an x-direction, 10 feet away in a y-axis direction, and 10 feet away in a z-direction. The system may move the sound source in 1-foot increments, so that the next testing location is at the point (9 feet, 10 feet, 10 feet), 9 feet away in the x-direction, 10-feet away in the y-direction, and 10 feet away in a z-direction, and so on. In other embodiments, the tested area and the increments may be smaller or greater.

At step 505, the sound source 200 emits a sound of known frequencies. The system then analyzes 510 the phase angles of all detected waves at the known frequencies. A “phase signature” table is then created 515 for the current spatial location. The phase signature table, as explained in further detail below with respect to FIG. 6, is a table of the emitted wave frequencies and the phase angles for each of the waves. The system then determines 520 whether it is at the final spatial location. If it is not at the final location, the system moves 525 the sound source 200 to the next location, and processing jumps to step 505. If the system determines 520 that the sound source 200 is at the final spatial location, the calibration process ends at step 530.

FIG. 6 illustrates a phase signature table 600 according to an embodiment of the present invention. As illustrated, the table 600 includes phase angles for four known frequencies, “120 Hz,” “145 Hz,” “160 Hz,” and “185 Hz.” In other embodiments, more than four frequencies may be tested. The phase signature table 600 contains the phase angles for known frequencies when the sound source is located at coordinates (4, 4, 4). There is a different phase signature table 600 for each spatial location of interest. As explained in further detail below, the phase signature tables 600 calculated during the calibration process are utilized as a priori data to determine the spatial location of a sound source 200. When a sound is detected from the sound source 200, the system determines phase angles for detected frequencies. Next, the system compares the analyzed data versus the known phase signature tables 600 at each spatial location of interest and determines which phase signature table 600 contains phase angles most closely matching the analyzed data.

The use of irregularly shaped acoustic reflectors such as the left 400 and right 405 reflectors shown in FIG. 4 may be superior to the use of straight reflectors because the phase angle difference between similar frequencies may be relatively larger than they would have been if straight reflectors had been utilized. Accordingly, irregularly shaped reflectors may add additional precision to the system.

The system applies the Generalized Cross Correlation PHAse Transform (“GCC-PHAT”) set forth by Knapp, C. H. and Carter, G. C., “The Generalized Correlation Method For Estimation Of Time Delay,” I.E.E.E. Trans. Acoust. Speech Signal Process., vol. ASSP-24, Pp. 320-27, August 1976. The use of the GCC-PHAT along with the pre-calculated phase signature 600 results in the following transform:

$$D ( q ) = {}_{- ∞} {\int }^{∞} Ψ ( ω ) {X}_{M1} ( ω ) {X}_{M2}^{*} ( ω ) {ⅇ}^{- jω ( S ( q , ω ) )} ⅆ ω$$

$$w h e r e Ψ ( ω ) ≡ 1 / \vert {X}_{M1} ( ω ) {X}_{M2}^{*} ( ω ) \vert$$

X represents the Fourier transform of a microphone signal, and * is the complex conjugate. ω represents frequency, q represents the spatial location of the sound source 200, S(q, ω) represents a set of phase angles for a particular spatial location and frequency, and D(q) represents the difference between the phase angles detected during an operation of the acoustic sound localization system 202 and the calibrated set of phase data for the spatial location q.

The system may then test the data from all spatial locations q to determine which results in the greatest value of D(q). Accordingly, using the equation qₛ=argmax(P(q)), qₛ is the spatial location at which the sound source 200 is located. The sound source can then be identified as the spatial location where D(q) is maximized.

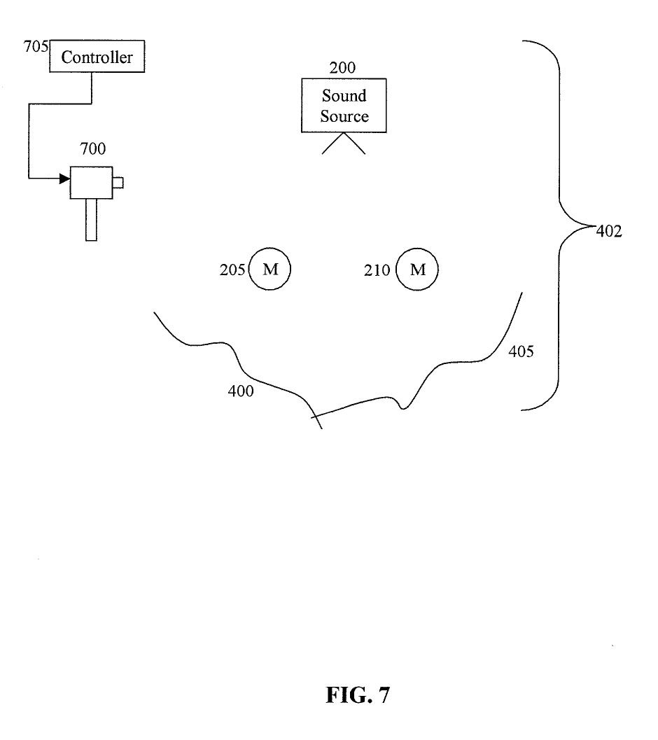

An embodiment of the present invention may be utilized in combination with a videoconferencing system, for example. FIG. 7 illustrates a videoconferencing system according to an embodiment of the present invention. The video conferencing system is similar to the acoustic localization system 402 of FIG. 4, except that a video camera 700 has been added. The videoconferencing system may be utilized to focus the video camera 700 in the direction of the detected spatial location of a sound source. For example, if a person in a conference room speaks, the system may first determine the spatial location of the speaker and then focus the video camera 700 in the direction of the speaker. If a different person then speaks, the video camera 700 may then determine the spatial location of the new speaker, and a controller 705 may focus the video camera 700 in the direction of the new speaker.

Other embodiments may utilize the location of the sound source 200 to more cleanly detect and output electrical signals from the microphones. For example, once the location of the sound source 200 has been determined, the system may set delays to delay the output of each of the microphones, so that the resultant summed output signal has more power. Accordingly, the Delayed Sum Beamformer method or the Filter and Sum Beamformer method may be utilized once the sound source's 200 location has been determined.

In a situation where many microphones are utilized, after the location of the sound source 200 has been determined, the system may selectively shut off certain microphones that are far from the speaker, or that have been calculated to be at a location of disinterest (e.g., microphones that simply add noise to a resultant signal). Further embodiments may be used for locating mammals or other animals in an underwater environment. For example, in a situation where a scientist is searching for a dolphin in a pool of water, once the dolphin make a noise, the dolphin's location may be determined. The dolphin's behavior may then be monitored, for example.

While the description above refers to particular embodiments of the present invention, it will be understood that many modifications may be made without departing from the spirit thereof The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A sound location detecting system, comprising:
a first microphone located at a first location to detect acoustic waves at the first location;
a second microphone located at a second location to detect the acoustic waves at the second location;
at least one acoustically reflective surface to reflect the acoustic waves;
an acoustic analysis device to detect and analyze the acoustic waves; and
a processing device to determine a spatial location of a source of the acoustic waves.

2. The sound location detecting system according to claim 1, wherein the at least one acoustically reflective surface has an irregular shape.

3. The sound location detecting system according to claim 1, wherein the at least one acoustically reflective surface is shaped like a human pinnea.

4. The sound location detecting system according to claim 1, wherein the at least one acoustically reflective surface has low acoustic absorption properties.

5. The sound location detecting system according to claim 1, wherein the processing device directs an observation device in a direction of the spatial location of the source of the acoustic waves.

6. The sound location detecting system according to claim 1, further including a calibration device to create a set of phase signature tables associating phase angles, between when the acoustic waves reach the first microphone and when the acoustic waves reach the second microphone, with detected frequencies at a predetermined spatial location.

7. A method of determining a spatial location of a source of acoustic waves, comprising:
using a first microphone to detect the acoustic waves at a first location;
using a second microphone to detect the acoustic waves at a second location;
using at least one acoustically reflective surface to reflect the acoustic waves in a direction of the first location and the second location;
analyzing the acoustic waves; and
determining a spatial location of a source of the acoustic waves.

8. The method according to claim 7, wherein the at least one acoustically reflective surface has an irregular shape.

9. The method according to claim 7, wherein the at least one acoustically reflective surface has low acoustic absorption properties.

10. The method according to claim 7, wherein the method further includes directing an observation device in a direction of the determined spatial location of the source of the acoustic waves.

11. The method according to claim 7, further including creating a set of phase signature tables associating phase angles, between when the acoustic waves reach the first location and when the acoustic waves reach the second location, with detected frequencies at a predetermined spatial location.

12. A sound location detecting device, comprising:
a computer-readable medium; and
a computer-readable program code, stored on the computer-readable medium, having instructions to
use a first microphone to detect acoustic waves at a first location;
use a second microphone to detect the acoustic waves at a second location;
reflect the acoustic waves in a direction of the first microphone and the second microphone;
analyze the acoustic waves; and
determine a spatial location of a source of the acoustic waves.

13. The sound location detecting device according to claim 12, wherein at least one acoustically reflective surface is utilized to reflect the acoustic waves.

14. The sound location detecting device according to claim 13, wherein the at least one acoustically reflective surface has an irregular shape.

15. The sound location detecting system according to claim 13, wherein the at least one acoustically reflective surface has low acoustic absorption properties.

16. The sound location detecting system according to claim 12, wherein the computer-readable program code includes instructions to direct an observation device in a direction of a determined spatial location of the source of the acoustic waves.

17. The sound location detecting system according to claim 12, wherein the computer-readable program code includes instructions to set a first delay to delay an output of the first microphone and a second delay to delay an output of the second microphone, based upon the spatial location of the source of the acoustic waves

18. The sound location detecting system according to claim 12, wherein the computer-readable program code includes instructions to create a set of phase signature tables associating phase angles, between when the acoustic waves reach the first location and when the acoustic waves reach the second location, with detected frequencies at a predetermined spatial location.

19. A method of creating a phase signature table, comprising:
emitting acoustic waves of known frequencies from predetermined spatial locations;
using a first microphone to detect the acoustic waves at a first location;
using a second microphone to detect the acoustic waves at a second location;
determining a phase angle between when the acoustic waves reach the first location and when the acoustic waves reach the second location, for each of the known frequencies; and
associating the phase angles with the known frequencies at each of the predetermined spatial locations.

20. The method according to claim 19, further including reflecting the acoustic waves in a direction of each of the first location and the second location.

21. The method according to claim 20, wherein at least one irregularly shaped surface is utilized to reflect the acoustic waves.

22. The method according to claim 21, wherein the at least one irregularly shaped surface is shaped like a human pinnea.

23. A phase signature table creation device, comprising:
a computer-readable medium; and
a computer-readable program code, stored on the computer-readable medium, having instructions to
emit acoustic waves of known frequencies from predetermined spatial locations;
use a first microphone to detect the acoustic waves at a first location;
use a second microphone to detect the acoustic waves at a second location;
determine a phase angle between when the acoustic waves reach the first location and when the acoustic waves reach the second location, for each of the known frequencies; and
associate the phase angles with the known frequencies at each of the predetermined spatial locations.

24. The phase signature table creation device according to claim 23, wherein the computer-readable program code includes instructions to reflect the acoustic waves in a direction of each of the first location and the second location.

25. The phase signature table creation device according to claim 23, wherein at least one irregularly shaped surface is utilized to reflect the acoustic waves.

26. The phase signature table creation device according to claim 25, wherein the at least one irregularly shaped surface is shaped like a human pinnea.
